(19) United States
(12) Patent Application Publication
(10) Pub. No.: US 2025/0247324 A1
(43) Pub. Date: Jul. 31, 2025

(54) GLOBAL FIRST NON-MINIMAL ROUTING IN DRAGONFLY TOPLOGIES

(71) Applicant: CORNELIS NETWORKS INC., WAYNE, PA (US)

(72) Inventor: ARUNA RAMANAN, EASTON, PA (US)

(73) Assignee: CORNELIS NETWORKS INC., WAYNE, PA (US)

(21) Appl. No.: 18/427,540

(22) Filed: Jan. 30, 2024

(51) Int. Cl. H04L 45/122; H04L 45/02; H04L 45/586

(52) U.S. Cl. CPC H04L 45/122; H04L 45/04; H04L 45/586

(57) ABSTRACT

Methods, systems, switches, and products are provided for global first, non-minimal routing in a Dragonfly topology. Embodiments include receiving, on a terminal link of a switch, a packet whose destination is in another VRG and routing, by the switch, the packet to a switch in another VRG on a global link.

### BACKGROUND

High-Performance Computing (‘HPC’) refers to the practice of aggregating computing in a way that delivers much higher computing power than traditional computers and servers. HPC, sometimes called supercomputing, is a way of processing huge volumes of data at very high speeds using multiple computers and storage devices linked by a cohesive fabric. HPC makes it possible to explore and find answers to some of the world's biggest problems in science, engineering, business, and others.

HPC systems support complex topologies of switches and links. A Dragonfly topology, for example, is a computing topology in which a collection of switches belonging to a virtual router group (‘VRG’) are connected all-to-all with intra-group connections called local links and are connected all-to-all with other VRGs with inter-group connections called global links. While it is possible to add more levels to the hierarchy, two level hierarchy, called a 1D Dragonfly or simply a Dragonfly, is most common configuration deployed in HPC interconnects.

When many endpoints of a group communicate with endpoints on another group, global links often become a severe bottleneck. This bottleneck is reduced by allowing non-minimal paths in which packets are sent to an intermediate group and then routed to the destination group. Such an intermediate group is called a pass-through VRG. This implies an L-G-L-G-L path, and which increases to L-G-L-L-G-L if the path uses the Valiant routing algorithm.

Conventional routing algorithms often require a packet received on a terminal link, (a packet at the source switch) to be first routed on a local link to another switch in the source VRG. Under these constraints, therefore, the shortest path between two endpoints that reside in different VRGs usually includes a local hop within the source VRG, a global hop to the destination VRG, and local hop to the destination switch. This is described as L-G-L, or local-global-local.

Global first, non-minimal routing according to embodiments of the present provides a routing algorithm for Dragonfly networks that reduces the maximum and average path length of packets through the network.

### BRIEF DESCRIPTION OF THE DRAWINGS

Many aspects of the present disclosure can be better understood with reference to the following drawings. The components in the drawings are not necessarily to scale, with emphasis instead being placed upon illustrating the principles of the disclosure. Moreover, in the drawings, like reference numerals designate corresponding parts throughout the several views.

FIG. 1 sets forth a system diagram illustrating an example high-performance computing environment according to embodiments of the present invention.

FIG. 2 sets forth a line drawing illustrating a VRG for global, first non-minimal routing according to embodiments of the present invention.

FIG. 3 sets forth a line drawing illustrating a number of possible the between a source switch and a destination switch using conventional routing algorithms without global first, non-minimal routing.

FIG. 4 sets forth a line drawing illustrating how the use of global first, non-minimal routing according to the present invention reduces the path length the source to the destination illustrated in FIG. 3.

FIG. 5 sets forth a line drawing illustrating a switch with global first, non-minimal routing according to embodiments of the present invention.

FIG. 6 sets forth a flow chart illustrating an example method of global first, non-minimal routing in a Dragonfly topology according to embodiments of the present invention.

### DETAILED DESCRIPTION

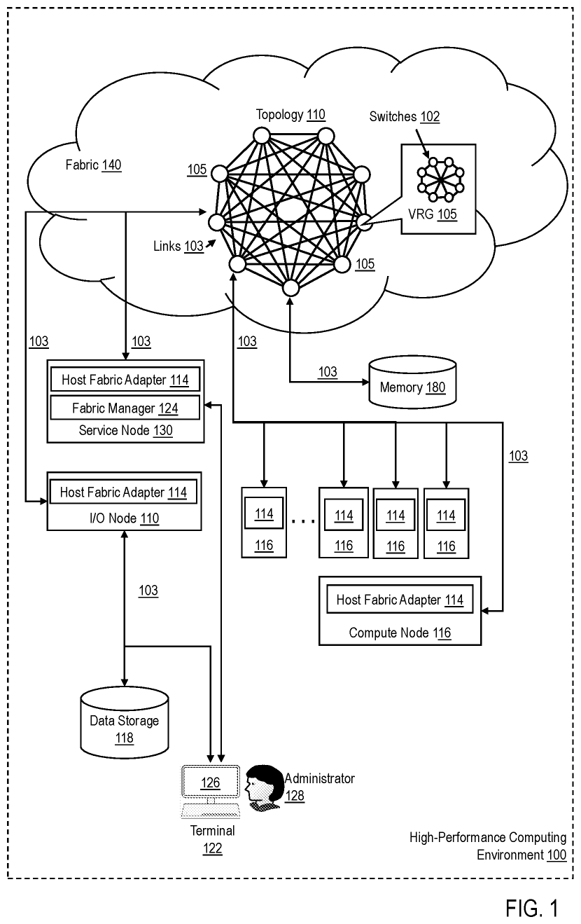

Global first, non-minimal routing according to embodiments of the present provides a routing algorithm for Dragonfly networks that reduces the maximum and average path length of packets through the network. FIG. 1 sets forth a system diagram illustrating an example high-performance computing environment useful for global-first non-minimal routing according to embodiments of the present invention. The example high-performance computing environment of FIG. 1 includes a fabric (140) which includes an aggregation of switches (102), links (103), and host fabric adapters (‘HFAs’) (114) integrating the fabric with the devices that it supports. The fabric (140) according to the example of FIG. 1 is a unified computing system that includes interconnected HFAs and switches that often look like a weave or a fabric when seen collectively.

The switches (102) of FIG. 1 are multiport modules of automated computing machinery, hardware and firmware, that receive and transmit packets. Typical switches receive packets, inspect packet header information, and transmit the packets according to routing tables configured in the switch. Switches are implemented as, or with, one or more application specific integrated circuits (‘ASICs’). In many cases, the hardware of the switch implements packet routing and firmware of the switch configures routing tables, performs management functions, fault recovery, and other complex control tasks as will occur to those of skill in the art.

The switches (102) of the fabric (140) of FIG. 1 are connected to other switches with links (103) to form one or more topologies. A topology is implemented as a wiring pattern among switches, HFAs, and other components. Switches, HFAs, and their links may be connected in many ways to form many topologies, each designed to optimize performance for their purpose.

The example of FIG. 1 depicts a Dragonfly topology (110) which is an all-to-all connected set of virtual router groups (105). Virtual router groups (‘VRGs’) (105) are themselves a collection of switches (102) with their own topology—in this case an all-to-all configuration. The switches (102) of FIG. 1 include terminal links to compute nodes, local links to other switches in the same VRG, and global links to switches in other VRGs. As discussed in more detail below, each switch (102) in each VRG (105) is configured for global first non-minimal routing according to embodiments of the present invention as described in more detail below.

The links (103) themselves may be implemented as copper cables, fiber optic cables, and others as will occur to those of skill in the art. In some embodiments, the use of double density cables may also provide increased bandwidth in the fabric. Such double density cables may be implemented with optical cables, passive copper cables, active copper cables and others as will occur to those of skill in the art.

The example of FIG. 1 includes a service node (130). The service node (130) provides services common to pluralities of compute nodes, loading programs into the compute nodes, starting program execution on the compute nodes, retrieving results of program operations on the compute nodes, and so on. The service node communicates with administrators (128) through a service application interconnect that runs on computer terminal (122).

The service node (130) of FIG. 1 has installed upon it a fabric manager (124). The fabric manager (124) of FIG. 1 is a module of automated computing machinery for configuring, monitoring, managing, maintaining, troubleshooting, and otherwise administering elements of the fabric (140). The example fabric manager (124) is coupled for data communications with a fabric manager administration module with a user interface (‘UI’) (126) allowing administrators (128) to configure and administer the fabric manager (124) through a terminal (122), and in so doing, configure and administer the fabric (140). In some embodiments of the present invention, routing algorithms are controlled by the fabric manager (124) which in some cases configures routes from endpoint to endpoint.

The fabric manager (124) of FIG. 1 configures the routing tables in the switches for global first, non-minimal routing according to embodiments of the present invention. The fabric manager of FIG. 1 is described as being a component of the service node. This is for example and not for limitation. Fabric managers useful with embodiments of the present invention may be installed on other nodes and with other configurations as will occur to those of skill in the art.

The example of FIG. 1 includes an I/O node (110) responsible for input and output to and from the high-performance computing environment. The I/O node (110) of FIG. 1 is coupled for data communications to data storage (118) and a terminal (122) providing information, resources, UI interaction and so on to an administrator (128).

The compute nodes (116) of FIG. 1 operate as individual computers including at least one central processing unit (‘CPU’), volatile working memory and non-volatile storage. The hardware architectures and specifications for the various compute nodes vary and all such architectures and specifications are well within the scope of the present invention as will occur to those of skill in the art. Such non-volatile storage may store one or more applications or programs for the compute node to execute.

Each compute node (116) in the example of FIG. 1 has installed upon it a host fabric adapter (114) (‘HFA’). An HFA is a hardware component that facilitates communication between a computer system and a network or storage fabric. It serves as an intermediary between the computer's internal bus architecture and the external network or storage infrastructure. The primary purpose of a host fabric adapter is to enable a computer to exchange data with other devices, such as servers, storage arrays, or networking equipment, over a specific communication protocol. HFAs deliver high bandwidth and increase cluster scalability and message rate while reducing latency.

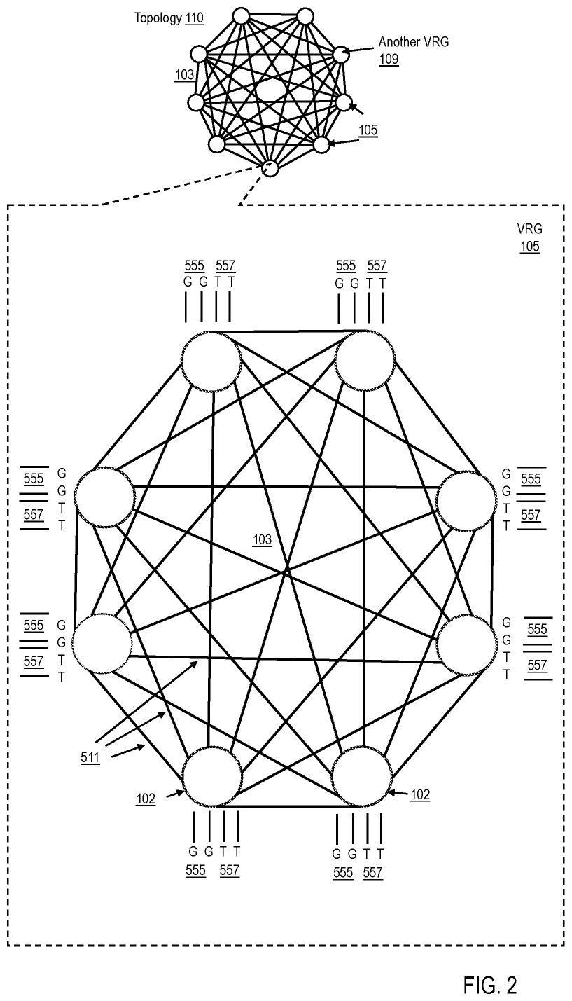

For further explanation, FIG. 2 sets forth a line drawing illustrating a Dragonfly topology with an exploded view of a VRG according to embodiments of the present invention. Global first, non-minimal routing according to embodiments of the present invention is described with reference to a Dragonfly topology (110) comprising a plurality of interconnected virtual routing groups (VRGs) (105). In the example of FIG. 2, each VRG (105) includes a plurality of interconnected switches (102). The switches (102) include terminal links (557) to compute nodes, local links (511) to other switches in the same VRG, and global links (555) to switches in other VRGs.

The switches (102) of FIG. 2 are configured for global first, non-minimal routing according to embodiments of the present invention. Each of the switches are configured to receive, on a terminal link (557) of the switch (102), a packet whose destination is in another VRG (109) and configured to route the packet to a switch in another VRG (109) on a global link (555). Routing the packet to another VRG on a global link of the source switch itself reduces the maximum and average path length of packets through the network by eliminating the required first local hop within the source VRG dictated by conventional algorithms.

This leads to an L:G ratio of 1:1 for a more balanced link usage. There are currently no known algorithms that can get close to 1:1 for existing global link connection patterns in industry and literature. The only known solution to reduce L:G ratio is Cyclic Dragonfly connections between groups (provide reference to filing here) which leads to L-G-G-L non-minimal paths. Such Cyclic Dragonfly connections are described in U.S. patent application Ser. No. 18/194,168, entitled Cyclic Dragonfly and Megafly, and U.S. patent application Ser. No. 18/194,667, entitled Creation of Cyclic Dragonfly and Megafly Cable Patterns, to Cornelis Networks Ser. No. 18/194,168 herein incorporated by reference in their entireties.

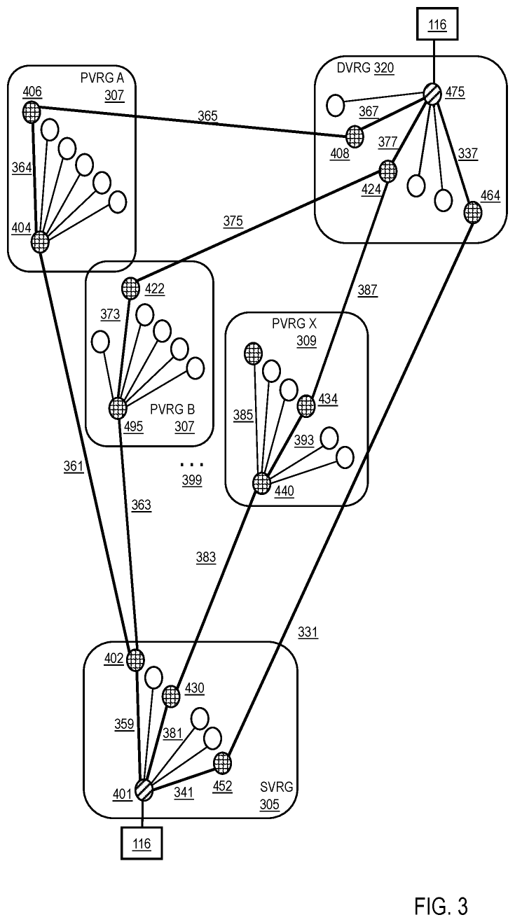

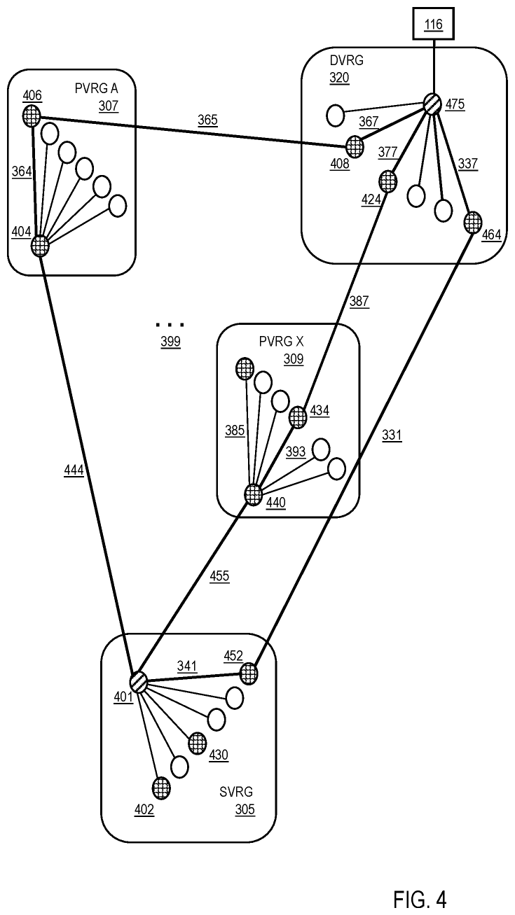

Global first non-minimal routing is a routing algorithm for Dragonfly networks that reduces the maximum and average path length of packets through the network. For further explanation, possible paths between source-destination pairs on different VRGs without global first, non-minimal routing are described with reference to FIG. 3. Those paths are then compared with possible paths using global first, non-minimal routing according to the present invention described with reference to FIG. 4.

As will occur to those of skill in the art, conventional non-minimal routing algorithms use pass-through VRGs to create multiple paths between source-destination pairs. The example of FIG. 3 illustrates three pass-through VRGs, PVRG A (307), PVRG B (308), and PVRG X (309) separated by ellipses (399). Ellipses (399) are used to designate that any number of pass-through VRGs may be available for non-minimal routing between the source switch and the destination switch.

Each pass-through VRG includes a number of switches arranged as shown in FIG. 2. The switches in the VRGs of FIG. 3 are illustrated according to their position in a one-dimensional path from the source to the destination. The switches of FIG. 3 are not illustrated according to their actual topological arrangement.

Conventional non-minimal routing algorithms usually require a first hop from the source switch (401) to another switch in the source VRG (305) on any path prior to using a global link to another VRG, such as a pass-through VRG to the destination (475). The example of FIG. 3 illustrates a number of possible paths between a source switch (401) in a source VRG (305) to a destination switch (475) in a destination VRG (320).

One example path in the example of FIG. 3 is defined by the hops between switches (401), (402), (404), (406), (408), and (475) using local link (359), global link (361), local link (364), global link (365), and local link (367), and using pass-through VRG A (307). This path is an LGLGL path.

Another possible path in this example is defined by the hops between switches (401), (402), (495), (422), (424), and (475) using local link (359), global link (363), local link (373), global link (375), and local link (377), and using pass-through VRG B (308). This path is an LGLGL path.

Another possible path in this example is defined by the hops between switches (401), (430), (440), (434), (424), and (475) using local link (381), global link (383), local link (393), global link (387), and local link (377), and using pass-through VRG X (309). This path is an LGLGL path.

As will occur to those of skill in the art, the minimal path is also illustrated in FIG. 3 which is defined by the hops between switches (401), (452) (464), and (475) using local link (341), global link (331), and local link (337). The minimal path is an LGL path.

Each of the non-minimal paths of FIG. 3 is an LGLGL path. That is, each of the paths includes a local first hop prior to the use of the passthrough VRG. FIG. 4 sets forth a line drawing illustrating how the use of global first, non-minimal routing according to the present invention reduces the path length the source to the destination illustrated in FIG. 3. Using global first, non-minimal routing two non-minimal paths from the source switch (401) to the destination switch (475) are illustrated. The paths of FIG. 4 are similar to those of FIG. 3, but in the case of FIG. 4, each of the available global link is available to switch (401) and is considered in routing the first hop. FIG. 4 illustrates the following paths:

One example illustrated in FIG. 4 path is defined by the hops between switches (401), (404), (406), (408), and (475) using global link (444), local link (364) global link (365), and local link (367), and using pass-through VRG A (307). This path is a GLGL path and is available because switch (401) has a global link (444) to switch (404) in pass-through VRG A (307).

Another possible path in this example is defined by the hops between switches (401), (440), (434), (424), and (475) using global link (455), local link (493), global link (387), and local link (377), and using pass-through VRG X (309). This path is a GLGL path and is available because switch (401) has a global link (455) to switch (440) in pass-through VRG X (309).

As will occur to those of skill in the art, the minimal path is also illustrated in FIG. 4. It is the same minimal path as illustrated in FIG. 3, which is defined by the hops between switches (401), (452) (464), and (475) using local link (341), global link (331), and local link (337). The minimal path is an LGL path.

Those of skill in the art will recognize that use of global first, non-minimal routing eliminates the use of pass-through VRGs that are not connected to a global link of the source switch. While the number of paths available using global first, non-minimal routing are fewer between any individual source and destination pair, those paths are shorter. Moreover, when taken generally between VRGs there are the same number of overall paths as in FIG. 3.

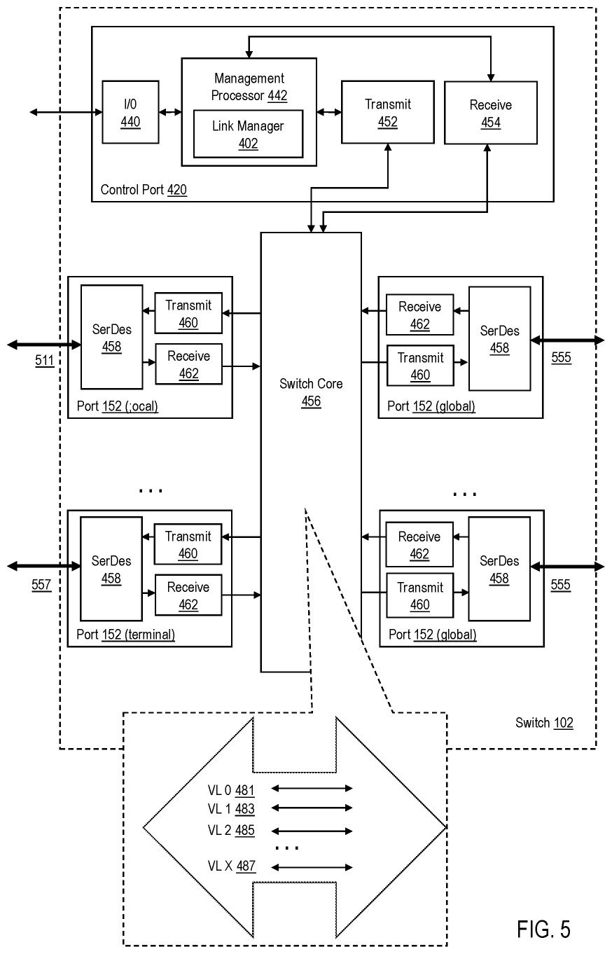

For further explanation, FIG. 5 sets forth a line drawing illustrating a switch for global first, non-minimal routing according to embodiments of the present invention. The example switch (102) of FIG. 5 includes a control port (420), a switch core (456), and a number of ports (152). The control port (420) of FIG. 5 includes an input/output (′I/O′) module (440), a management processor (442), a transmit controller (452), and a receive controller (454). The management processor (442) of the example switch of FIG. 5 maintains and updates routing tables for the switch. In the example of FIG. 5, each receive controller maintains the latest updated routing tables.

Each port (152) is coupled with the switch core (456) and a transmit controller (460) and a receive controller (462) and a SerDes (458). Each port in FIG. 5 is connected to a local link (511), a global link (555), or a terminal link (557). For ease of explanation, only one global link, one terminal link, and two local links are depicted in the example of FIG. 5. Those of skill in the art will appreciate that switches according to embodiment of the present invention will accommodate many global links, terminal links, and local links.

The switch of FIG. 5 supports virtual lanes. Each virtual lane operates independently, allowing traffic to be segregated based on priority, message type, or other factors such as deadlock prevention.

The switch of FIG. 5 is configured for global first, non-minimal routing in a Dragonfly topology according to embodiments of the present invention. As mentioned above, a Dragonfly topology includes a plurality of interconnected virtual routing groups (VRGs) (105), wherein each VRG (105) includes a plurality of interconnected switches (102). As in this example, the switches (102) include terminal links (557) to compute nodes, local links (511) to other switches in the same VRG, and global links (555) to switches in other VRGs.

The switch core (456) is configured for global first, non-minimal routing according to embodiments of the present invention. The switch core is configured to receive a packet on a terminal link (557) whose destination is in another VRG and route the packet to a switch in another VRG on a global link (555).

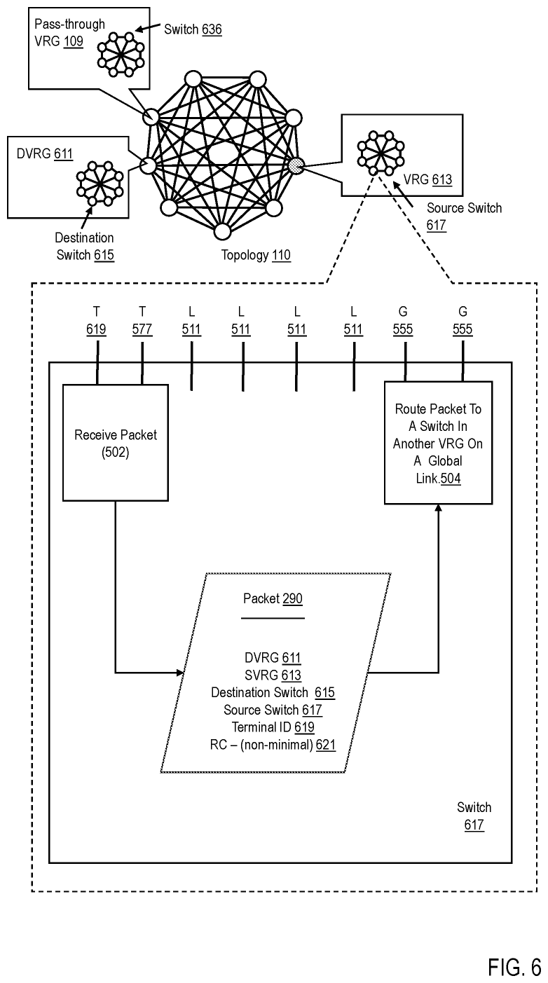

For further explanation, FIG. 6 sets forth a flow chart illustrating an example method of global first, non-minimal routing in a Dragonfly topology according to embodiments of the present invention. The Dragonfly topology of FIG. 6 includes a plurality of interconnected virtual routing groups (VRGs). Each VRG includes a plurality of interconnected switches including terminal links (557) to compute nodes, local links (511) to other switches in the same VRG, and global links (555) to switches in other VRGs. Each VRG also has at least one switch with a link to every other VRG.

The method of FIG. 6 includes receiving (502), on a terminal link (619) of a switch (617), a packet (290) whose destination is in another VRG (611). In the example of FIG. 6, the packet includes an identification of the destination VRG (611), the source VRG (613), the destination switch (615), the source witch (617), the terminal ID (619) and route control (621) (non-minimal).

The method of FIG. 6 includes routing (504) the packet (290) to a switch (636) in another VRG (109) on a global link (555). Routing, by the switch, the packet to a switch in another VRG on a global link may be carried out by transmitting the packet on a port on the switch connected to a global link based on local routing decisions that include use of the global link. In typical embodiments, non-minimal routing includes routing the packet to a pass-through VRG to which the switch has a global link. In the example of FIG. 6, the source switch (617) routes the packet on a global link to a switch (636) in pass-through VRG (109). Switch (636) then transmits the packet along the non-minimal path to the destination (615).

When source and destination are in different VRGs, the most general minimum path is L−G−L. As recognized, non-minimal routing is needed to avoid bottlenecks. Such non-minimal path selection can be achieved by identifying an intermediate or pass-through group, and optionally a group-router combination, either at random or using advanced criteria such as congestion level along those paths. As per this invention, the pass-through group will be selected from amongst those groups that are directly linked by a G link.

Note the number of non-minimal paths between a pair of VRGs is (S*G−1) when there is only one global link between the two VRGs, where S is the number of switches in a VRG and G is the number of global links on a switch. Of these, under standard algorithms, (S−1)*G will be used by any specific source-destination endpoint pair. Under GFNM, a source-destination endpoint pair will use G paths for the T terminals on the source router, with one router that is directly connected to destination having G−1 non-minimal paths. As a result, source routers utilize different pass-through groups eliminating contention between terminals on different routers in the source group.

Two distinct advantages of global first, non-minimal routing include less routers and more traffic classes. Consider a 48-port switch router. Standard configurations require a 1:2:1 T:L:G port ratio leading to groups with 24 switches (23 L links), 12 terminals and 12 global per switch. A 1:1:1 T:L:G port ratio would mean 16 switches (15 L links), 16 Terminals and 16 global per switch. A 64Ki cluster using 1:2:1 configuration will require 65,536/(24*12)=227.5 rounded up to 228 groups-a total of 228*24=5,472 switches. A 1:1:1 configuration will need 65,536/(16*16)=256 groups with a total of 256*15=4,096 switches. The latter configuration running GFNM routing algorithm can provide a better price performance ratio.

Consider a switch ASIC that supports 8 VLs. Under the Valiant algorithm (L-G-L-L-G-L routing scheme), 4 L VLs and 2 G VLs are necessary to avoid packet deadlock in the network. This would mean only two isolated traffic classes are possible. If protocols require separation between requests and responses to avoid protocol deadlocks, at an application point of view a total of 8 L VLs and 4 G VLs are needed. No application isolation over VLs will be possible. With the current invention, taking into account protocol deadlock avoidance requirement, only 4 VLs are needed per application there by allowing two applications to be run with VL isolation.

When implementations have limits on the number of virtual lanes (‘VLs’) that can be supported in the ASIC. The ability to reduce the number of VLs needed to avoid deadlocks will free some VLs for supporting additional virtual fabrics, which are needed when traffic isolation amongst multiple concurrent applications is needed.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of global first, non-minimal routing in a Dragonfly topology, the Dragonfly topology comprising a plurality of interconnected virtual routing groups (VRGs), wherein each VRG includes a plurality of interconnected switches, wherein the switches include terminal links to compute nodes, local links to other switches in the same VRG, and global links to switches in other VRGs; and the method comprises:
receiving, on a terminal link of a switch, a packet whose destination is in another VRG,
routing, by the switch, the packet to a switch in another VRG on a global link.

2. The method of claim 1 wherein routing, by the switch, the packet to a switch in another VRG on a global link further comprises transmitting the packet on a port on the switch connected to a global link based on local routing decisions that include use of the global link.

3. The method of claim 1 wherein routing, by the switch, the packet to a switch in another VRG on a global link further comprises transmitting the packet on a port on the switch connected to a local link based on local routing decisions that include use of a global link on the switch.

4. The method of claim 1 wherein routing, by the switch, the packet to a switch in another VRG on a global link further comprises transmitting the packet on a port on the switch connected to a global link.

5. The method of claim 1 wherein routing, by the switch, the packet to a switch in another VRG on a global link further comprises routing the packet to the destination VRG.

6. The method of claim 1 wherein routing, by the switch, the packet to a switch in another VRG on a global link further comprises routing the packet to a pass-through VRG.

7. A switch with global first, non-minimal routing in a Dragonfly topology, the Dragonfly topology comprising a plurality of interconnected virtual routing groups (VRGs), wherein each VRG includes a plurality of interconnected switches, wherein the switches include terminal links to compute nodes, local links to other switches in the same VRG, and global links to switches in other VRGs; and the switch comprises:
a plurality of ports including a transmit controller and a receive controller;
a control port comprising a management processor and transmit controller and a receive controller; and
a switch core configured to:
receive, on a terminal link of a switch, a packet whose destination is in another VRG,
route, by the switch, the packet to a switch in another VRG on a global link.

8. The switch of claim 7 wherein the switch core is further configured to transmit the packet on a port on the switch connected to a global link based on local routing decisions that include use of the global link.

9. The switch of claim 7 wherein the switch core is further configured to transmit the packet on a port on the switch connected to a local link based on local routing decisions that include use of a global link on the switch.

10. The switch of claim 7 wherein the switch core is further configured to transmit the packet on a port on the switch connected to a global link.

11. The switch of claim 7 wherein the switch core is further configured to route the packet to the destination VRG.

12. The switch of claim 7 wherein the switch core is further configured to route the packet to a pass-through VRG.

13. A system of global first, non-minimal routing in a Dragonfly topology, the Dragonfly topology comprising a plurality of interconnected virtual routing groups (VRGs) (105), wherein each VRG (105) includes a plurality of interconnected switches (102), wherein the switches (102) include terminal links (557) to compute nodes, local links (511) to other switches in the same VRG, and global links (555) to switches in other VRGs; and the system comprises:
means for receiving (502), on a terminal link (557) of a switch (102), a packet (290) whose destination is in another VRG,
means for routing (504), by the switch (102), the packet (290) to a switch in another VRG on a global link (555).

14. The system of claim 13 wherein means for routing, by the switch, the packet to a switch in another VRG on a global link further comprises means for transmitting the packet on a port on the switch connected to a global link based on local routing decisions that include use of the global link.

15. The system of claim 13 wherein means for routing, by the switch, the packet to a switch in another VRG on a global link further comprises means for transmitting the packet on a port on the switch connected to a local link based on local routing decisions that include use of a global link on the switch.

16. The system of claim 13 wherein means for routing, by the switch, the packet to a switch in another VRG on a global link further comprises means for transmitting the packet on a port on the switch connected to a global link.

17. The system of claim 13 wherein means for routing, by the switch, the packet to a switch in another VRG on a global link further comprises means for routing the packet to the destination VRG.

18. The system of claim 13 wherein means for routing, by the switch, the packet to a switch in another VRG on a global link further comprises means for routing the packet to a pass-through VRG.

19. A routing algorithm for non-minimal routing in a Dragonfly topology, the Dragonfly topology comprising a plurality of interconnected virtual routing groups (VRGs), wherein each VRG includes a plurality of interconnected switches, wherein the switches include terminal links to compute nodes, local links to other switches in the same VRG, and global links to switches in other VRGs, the routing algorithm comprising routing, by a source switch on the first hop, a packet to a switch in another VRG on a global link.
